(19) United States
(12) Patent Application Publication
(10) Pub. No.: US 2003/0072268 A1
(43) Pub. Date: Apr. 17, 2003

(54) Ring network system

(76) Inventors: Kazuto Nishimura, Kawasaki (JP); Jun Tanaka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/091,925

(22) Filed: Mar. 6, 2002

(30) Foreign Application Priority Data
Oct. 15, 2001 (JP) 2001-316942

(51) Int. Cl. H04L 12/26; H04L 12/28

(52) U.S. Cl. 370/252; 370/403

(57) ABSTRACT

A node in a ring network system in which a plurality of nodes are connected in loop through a ring transmission path, includes a storage unit having storage areas according to insertion nodes at which arrived packets are inserted into the ring transmission path, and accumulating the packets in the storage areas according to the insertion nodes, and a read control unit reading the packets in a fair way on the basis of predetermined weights respectively from the storage areas according to the insertion nodes.

### BACKGROUND OF THE INVENTION

The present invention relates to a ring network system for forwarding (which includes switching and transmitting) packets in a ring network where a plurality of nodes are connected in loop via a ring transmission path.

In the ring network system, the ring network is configured by utilizing a technology such as Token Ring, FDDI (Fiber Distributed Data Interface), SONET/SDH (Synchronous Optical Network/Synchronous Digital Hierarchy) and DTP (Dynamic Packet Transport: Cisco Systems Corp.).

Herein, an access control frame known as a token flow on the ring transmission path (that may be simply called a ring in some cases), each node can transmit the data by acquiring this token. Further, Token Ring is designed for LAN (Local Area Network), and a data transmission speed thereof is on the order of 16 Mb/s.

FDDI has a data transmission speed on the order of 100 Mb/s and performs access control using the token as by Token Ring.

SONET/SDH involves the use of a TDM (Time Division Multiplexing) transmission system known as Synchronous Digital Hierarchy, wherein a bandwidth is fixedly allocated to each connection. SONET/SDH is capable of the high-speed communications, wherein its transmission speed is as fast as 2.4 Gb/s or 10 Gb/s, and protection functions such as performance monitoring, self-healing and ring duplicating are provided.

DPT is capable of configuring a high-speed ring having a transmission speed on the order of 2.4 Gb/s or 10 Gb/s as by SONET/SDH, and is defined as a protocol suited to a burst traffic as seen in IP (Internet Protocol) communications.

Further, DPT adopts a dual ring architecture as in the case of SONET/SDH and is capable of transmitting the data also to a stand by ring and performing highly efficient communications.

Moreover, DPT uses an algorithm known as SRP-fa (Special Reuse Protocol-fairness algorithm), thereby actualizing the fairness between the nodes. For details of SRP-fa, refer to URL

[http://cco-sj-2.cisco.com/japanese/warp/public/3/jp/product/tech/wan/dpt/tech/dptm-wp.html].

Token Ring and FDDI are the architectures suitable for an IP traffic transport, wherein the fairness is actualized by giving admissions in sequence to all the nodes by use of the tokens. Token Ring and FDDI adopt this type of accessing scheme and therefore has a problem of their being unable to increase a throughput.

SONET/SDH may be categorized as a TDM-based ring configuring technology, in which a previously allocated bandwidth is invariably usable and therefore a fir bandwidth allocation corresponding to a reserved bandwidth can be attained. The bandwidth is, however, occupied even when there is no data, so that there arises a problem of being unsuited to the communications of an inefficient burst IP traffic.

DPT is a transmission technology for obviating those problems and capable of the high-speed transmission and the efficient use of the bandwidth as well. Further, DPT schemes to actualize the fairness between the nodes by use of SRP-fa.

According to DPT, however, SRP-fa needs complicated calculations of the bandwidths in order to actualize the fairness and a very complicated mechanism such as involving the use of a control packet for notifying of the bandwidth. Moreover, the packets (traffic) arriving there from the ring are queued up into the same FIFO queue, with the result that a certain node is inevitably affected in delay characteristic by other nodes.

### SUMMARY OF THE INVENTION

It is a primary object of the present invention to provide a technique and a method capable of allocating bandwidths to respective nodes in a fair way in a ring network system with a simple architecture and by simple processes.

To accomplish the above object, according to one aspect of the present invention, a first node in a ring network system in which a plurality of nodes are connected in loop through a ring transmission path, comprises a storage unit having storage areas according to insertion nodes at which arrived packets are inserted into the ring transmission path, and accumulating the packets in the storage areas according to the insertion nodes, and a read control unit reading the packets in a fair way on the basis of predetermined weights respectively from the storage areas according to the insertion nodes.

A second node according to the present invention may further comprise an identifying unit identifying the insertion node at which the packets are inserted into the ring transmission path on the basis of specifying information contained in the packet, and an accumulation control unit accumulating the packets in the corresponding every-insertion-node oriented storage area on the basis of a result of identifying the insertion node.

In a third node according to the present invention, the every-insertion-node oriented storage area of the storage unit is physically segmented into a plurality of areas, and the accumulation control unit permits only the packet from the corresponding insertion node to be written to each of the segmented areas of the every-insertion-node oriented storage area.

In a fourth node according to the present invention, the every-insertion-node oriented storage areas of the storage unit are provided by dynamically logically segmenting a shared storage area, and the accumulation control unit writes the packet from the corresponding insertion node to each of the every-insertion-node oriented storage areas into which the shared storage area is dynamically logically segmented.

A fifth node according to the present invention may comprise a storage module stored with mappings between traffic identifiers of the packets and the insertion node numbers, and the identifying unit identifies the insertion node at which the packet is inserted into the ring transmission path on the basis of the insertion node number corresponding to the traffic identifier, as the specifying information contained in the packet, which is obtained by referring to the storage module.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a diagram showing a system architecture in one embodiment of the present invention;

FIG. 2 is a block diagram showing an example of an architecture of a node shown in FIG. 1;

FIG. 3 is a block diagram showing an example of an architecture of a read control unit shown in FIG. 1;

FIG. 4 is a block diagram showing an example of an architecture of the read control unit shown in FIG. 1;

FIG. 5 is a block diagram showing an example of an architecture of the read control unit shown in FIG. 1;

FIG. 6 is an explanatory diagram showing an example of an architecture of the read control unit shown in FIG. 5;

FIG. 7 is a block diagram showing an example of an architecture of the read control unit shown in FIG. 1;

FIG. 8 is an explanatory diagram showing an example of an architecture of the read control unit shown in FIG. 7;

FIG. 9 is a block diagram showing an example of an architecture of an insertion node identifying unit shown in FIG. 1;

FIG. 10 is a diagram showing a packet format containing an insertion node number field;

FIG. 11 is a block diagram showing an example of an architecture of the insertion node identifying unit shown in FIG. 1;

FIG. 12 is a block diagram showing an example of an architecture of an every-insertion-node oriented buffer unit shown in FIG. 1; and

FIG. 13 is a block diagram showing an example of an architecture of the every-insertion-node oriented buffer unit shown in FIG. 1.

### DETAILED DESCRIPTION OF THE PREFERRED EMBODIMENTS

Embodiments of the present invention will hereinafter be discussed with reference to the accompanying drawings.

Architecture of Ring Network System

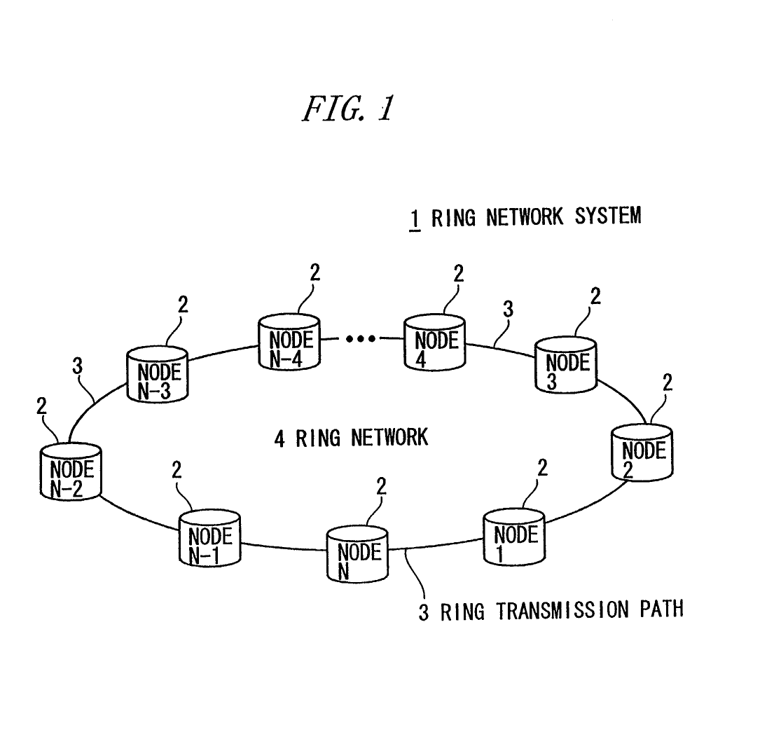

FIG. 1 illustrates a system architecture in one embodiment of the present invention. Referring to FIG. 1, a ring network system 1 includes a plurality of nodes (1, 2, . . . , N) 2 each accommodating a plurality of unillustrated terminals.

The plurality of nodes 2 are connected in loop through a ring transmission path 3, thus configuring a ring network 4. Each of the nodes 2 is a broadband switch such as a packet switch, or a packet transmission device such as a cross connect switch.

In this ring network system 1, the ring network 4 forwards (the term “forwarding” includes switching and transmitting) data (packet) transmitted from a terminal (source terminal) accommodated in a certain node 2 to a terminal (destination terminal) accommodated in other node 2.

In the ring network system 1, the node 2 that accommodates the source terminal and inserts the packet into the ring network 4 (more precisely into the ring transmission path 3), is called an [insertion node].

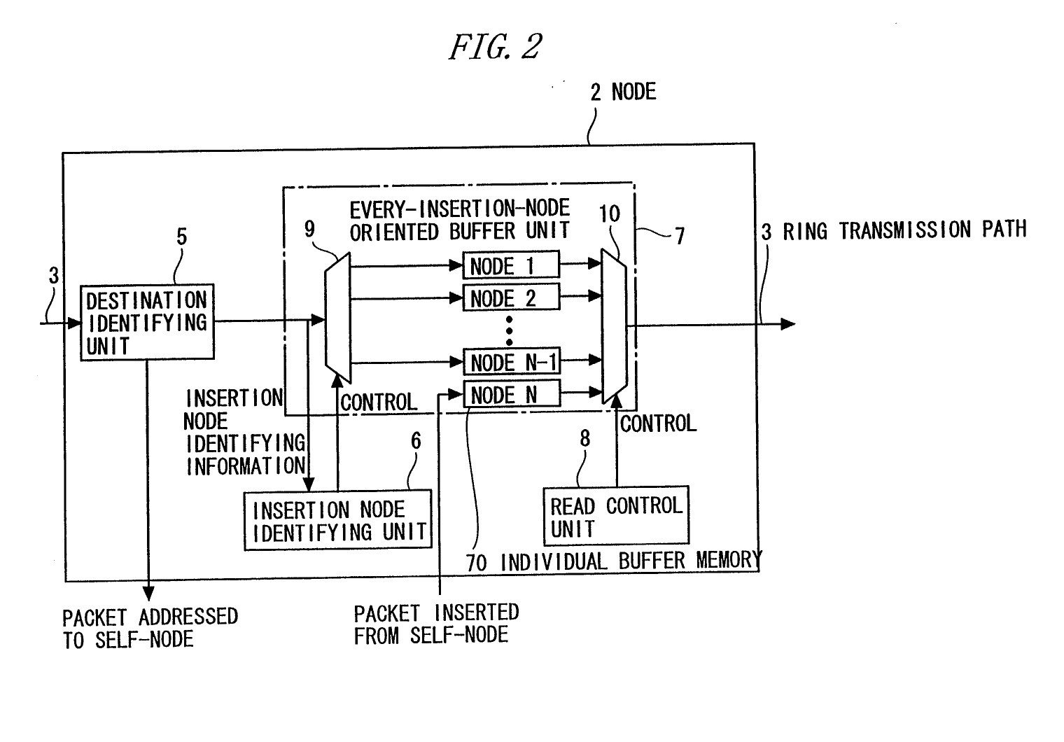

FIG. 2 shows an example of an architecture of each of the nodes 2 configuring the ring network 4 in the ring network system 1 described above. As shown in FIG. 2, each node 2 is constructed of a destination identifying unit 5, an insertion node identifying unit 6, an every-insertion-node oriented buffer unit 7, a read control unit 8, a multiplexing/demultiplexing module 9 and a-multiplexing module 10.

The destination identifying unit 5 identifies a destination of the packet arrived via the ring transmission path 3 on the basis of a piece of destination node information registered in a header field. The destination identifying unit 5, if this packet is addressed to the self-node, extracts this packet out of the ring transmission path 3 and, whereas if not, lets this packet send through the ring transmission path 3. The self-node addressed packet extracted by the destination identifying unit 5 is forwarded to the terminal accommodated in the self-node.

The insertion node identifying unit 6 extracts a piece of insertion node identifying information registered in the header field of each of the packets sent from the destination identifying unit 5, and controls the multiplexing/demultiplexing module 9 so as to properly allocate the packets to individual buffer memories of the every-insertion-node oriented buffer unit 7 through the multiplexing/demultiplexing module 9.

The every-insertion-node oriented buffer unit 7 in a first architecture example includes the multiplexing/demultiplexing module 9 and the multiplexing module 10. This every-insertion-node oriented buffer unit 7 has a plurality of individual buffer memories 70 arranged in physical or logical separation, corresponding to a node count [N] of the nodes connected to the ring transmission path 3, and caches the packets according to the insertion nodes (1 through N). The packets inserted into the ring transmission path 3 from the self-node are queued up into the individual buffer memories 70 corresponding to the N-pieces of nodes.

The read control unit 8 controls the multiplexing module 10 so that the packets are weighted and thus read from the individual buffer memories 70 in a way that causes no unfairness between the plurality of nodes 2.

The node 2 having this architecture needs neither a permission for transmitting the data as needed in the token ring nor a mechanism such as SRF-fa for receiving and transferring complicated pieces of inter-node information like congestion data, whereby a fair bandwidth allocation between the plurality of nodes 2 can be attained.

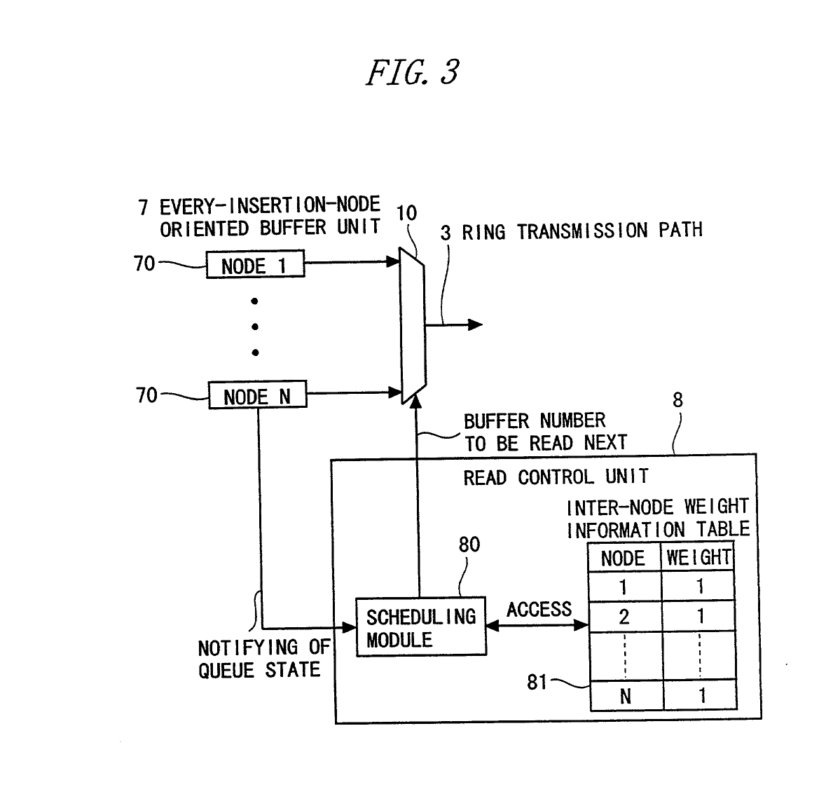

FIG. 3 shows an example of an architecture of the read control unit 8, to which a first weighted read control scheme is applied. As illustrated in FIG. 3, this read control unit 8 includes a scheduling module 80 that implements the weighted read control scheme based on a scheduling algorithm such as WFQ (Weighted Fair Queuing) by which the packetized data can be read in a fair way, and an inter-node weight information table 81 stored with read ratios of the plurality of nodes (1 through N).

Herein, a weight “1” to the individual buffer memories 70 is uniformly set in the inter-node weight information table 81. The scheduling module 80 notified of a queuing state (in the buffer memories) from the every-insertion-node oriented buffer unit 7, accesses the inter-node weight information table 81 and judges that the weights set to the individual buffer memories 70 are uniform. Then, the scheduling module 80 controls the multiplexing module 10 to read the packets by uniform weighting from the individual buffer memories 70.

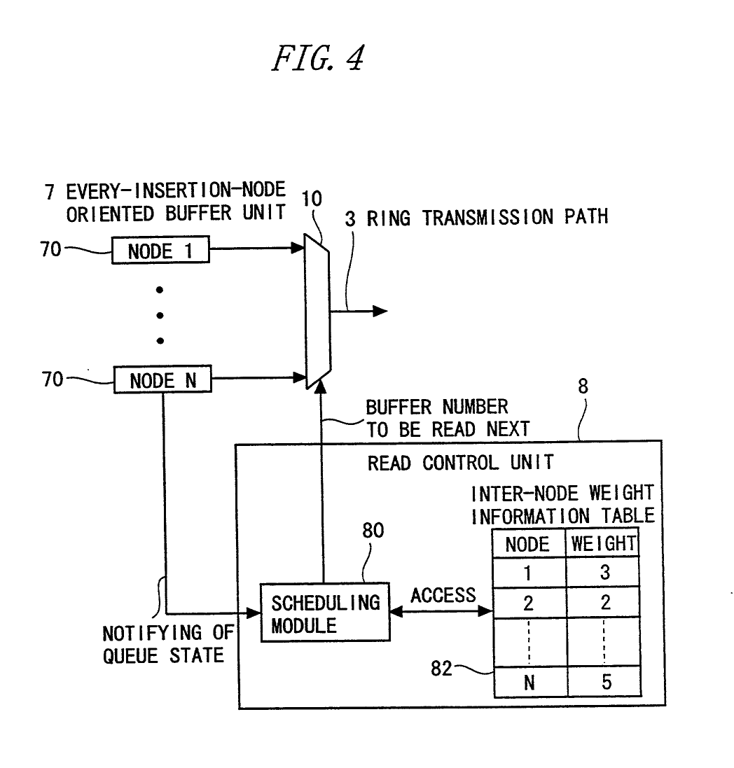

FIG. 4 shows an example of an architecture of the read control unit 8, to which a second weighted read control scheme is applied. As shown in FIG. 4, the read control unit 8 includes the scheduling module 80 that implements the weighted read control scheme based on the scheduling algorithm such as WFQ etc by which the packetized data can be read in the fair way, and an inter-node weight information table 82 stored with read ratios of the plurality of nodes (1 through N).

Herein, in the inter-node weight information table 82, there are set arbitrary differences between the weights given to the individual buffer memories 70. Namely, this read control unit 8, with the arbitrary weight differences being set in the inter-node weight information table 82 on the basis of statistic data of the respective nodes, executes the read control scheme based on an arbitrary fairness rule.

The scheduling module 80 notified of a queuing state from the every-insertion-node oriented buffer unit 7, accesses the inter-node weight information table 82 and judges the weights set with respect to the individual buffer memories 70. Then, the scheduling module 80 controls the multiplexing module to prioritize reading the packets by arbitrary differential weighting from the individual buffer memories 70.

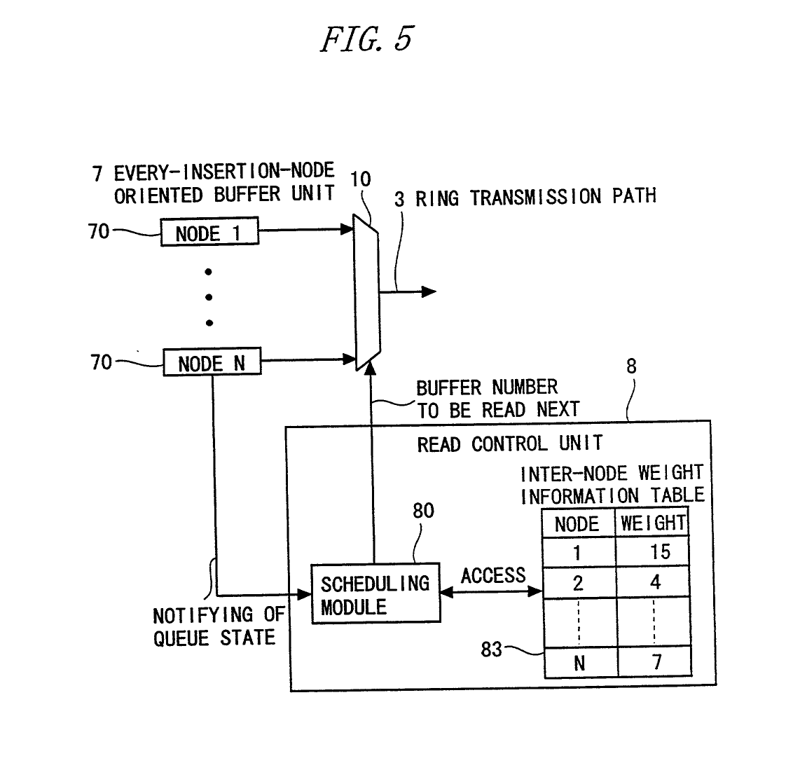

FIG. 5 shows an example of an architecture of the read control unit 8, to which a third weighted read control scheme is applied. As shown in FIG. 5, the read control unit 8 includes the scheduling module 80 that implements the weighted read control scheme based on the scheduling algorithm such as WFQ etc by which the packetized data can be read in the fair way, and an inter-node weight information table 83 stored with read ratios of the plurality of nodes (1 through N).

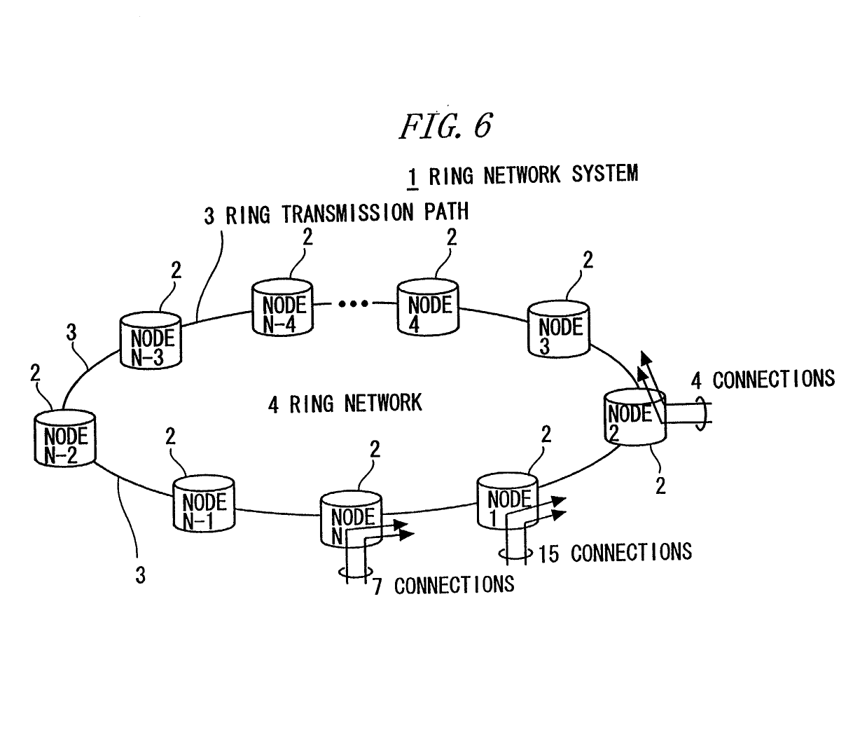

Herein, in the inter-node weight information table 83, there are set arbitrary differences between the weights given to the individual buffer memories 70. Namely, this read control unit 8, as in an example of the architecture of the ring network system 1 illustrated in FIG. 6, gives the fairness of allocating the bandwidths in proportion to the number of dynamic/static insertion connections to the ring transmission path 3 of the ring network 4 through the respective nodes 2.

The scheduling module 80 notified of a queuing state from the every-insertion-node oriented buffer unit 7, accesses the inter-node weight information table 83 and judges the connection-count-based weights set to the individual buffer memories 70. Then, the scheduling module 80 controls the multiplexing module to prioritize reading the packets by this differential weighting from the individual buffer memories 70.

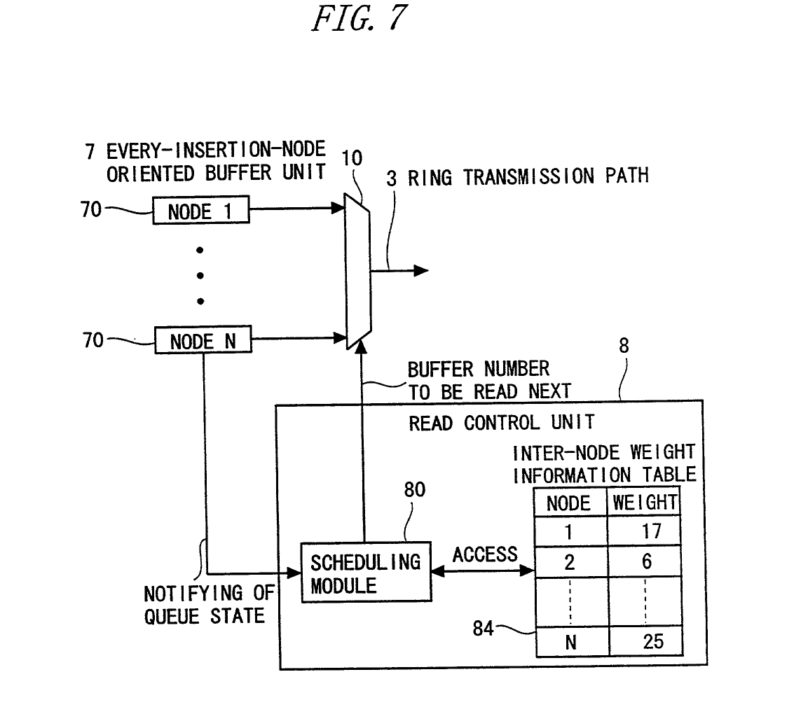

FIG. 7 shows an example of an architecture of the read control unit 8, to which a fourth weighted read control scheme is applied. As shown in FIG. 7, the read control unit 8 includes the scheduling module 80 that implements the weighted read control scheme based on the scheduling algorithm such as WFQ etc by which the packetized data can be read in the fair way, and an inter-node weight information table 84 stored with read ratios of the plurality of nodes (1 through N).

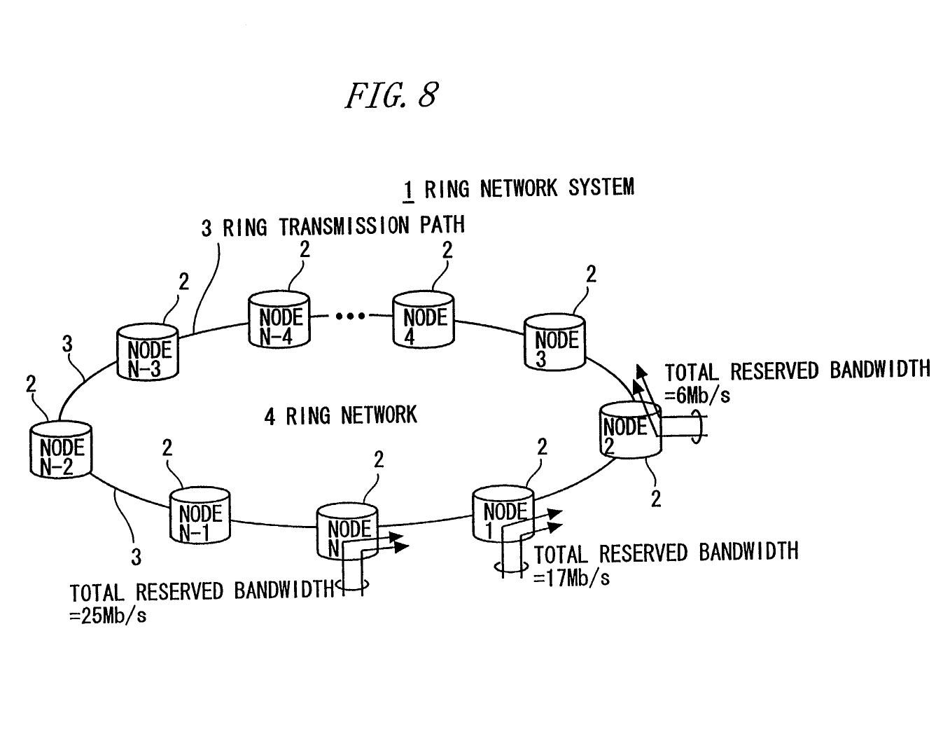

Herein, in the inter-node weight information table 84, there are set specified differences between the weights given to the individual buffer memories 70. Namely, this read control unit 8, as in an example of the architecture of the ring network system 1 illustrated in FIG. 8, gives the fairness of allocating the bandwidths in proportion to a sum of reserved bandwidths (total reserved bandwidths) of the connections for packet insertions into the ring transmission path 3 through the respective nodes 2.

The scheduling module 80 notified of a queuing state from the every-insertion-node oriented buffer unit 7, accesses the inter-node weight information table 84 and judges the total-reserved-bandwidths-based weights set to the individual buffer memories 70. Then, the scheduling module 80 controls the multiplexing module to prioritize reading the packets by this differential weighting from the individual buffer memories 70.

In the case of taking the architectures of the read control unit 8, to which the first through fourth weighted read control schemes are applied, there are given below two methods of setting the weights in the inter-node weight information table 81, 82, 83 or 84 of each node 2 in the ring network 4.

A first method is that an operator monitoring the entire ring network 4 manually sets the weight values in the inter-node weight information table 81, 82, 83 or 84 of each node 2.

A second method is that a control packet for setting the weights is provided beforehand, the weight values in the inter-node weight information table 81, 82, 83 or 84 are set and changed based on information of this control packet.

In the case of taking the second method, the procedures of changing the weight values are given as follows:

(1) Changes in the insertion connection count and in the reserved bandwidth occur in a certain node 2.

(2) This node 2 sends the control packet containing the changed values described therein to the ring transmission path 3 of the ring network 4.

(3) Other node 2 receiving this control packet updates the weight values in the inter-node weight information table 81, 82, 83 or 84.

(4) If the changes affect even the downstream nodes 2 in the ring network 4, the control packet is forwarded to the downstream nodes 2. If not affected, the control packet is discarded.

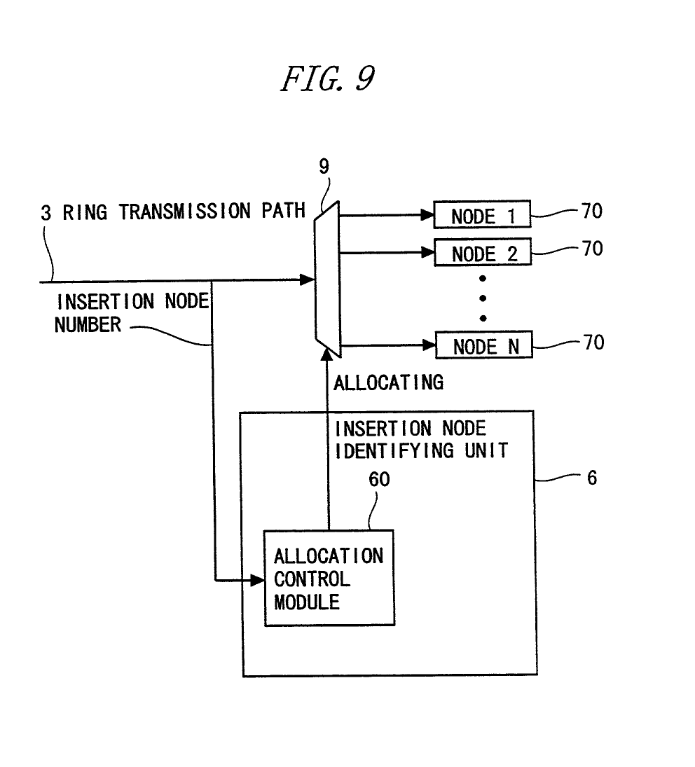

FIG. 9 shows an example of an architecture of the insertion node identifying unit 6, to which a first packet allocation control scheme is applied. As shown in FIG. 9, an allocation control module 60 in this insertion node identifying unit 6, when the packets arrive at the node 2 via the ring transmission path 3, extracts insertion node numbers as insertion node identifying information, and controls the multiplexing/demultiplexing module 9 so that the packets are properly allocated to the individual buffer memories 70 of the every-insertion-node oriented buffer unit 7 on the basis of the insertion node numbers.

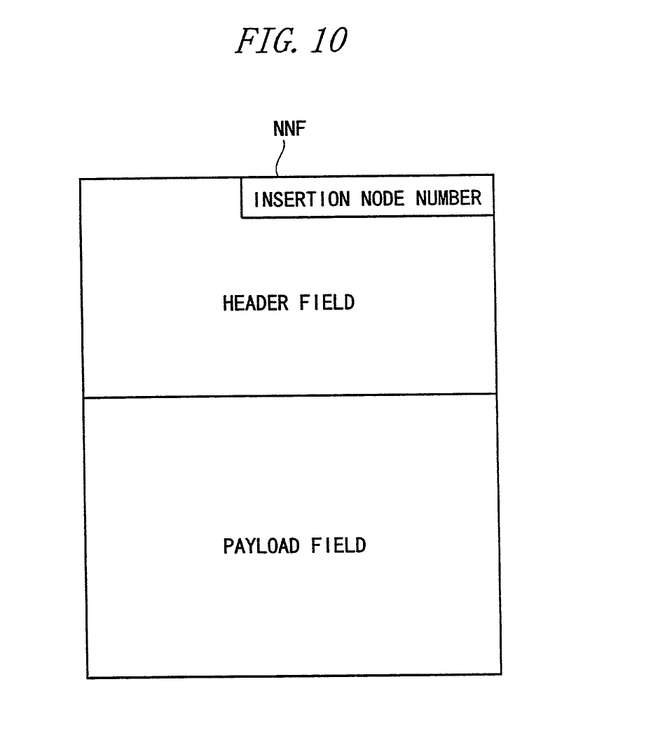

For enabling the allocation control module 60 to execute the packet allocation control scheme described above, as illustrated in FIG. 10, in the packet having the header field and the payload field, there is previously specified a packet format designed only for an interior of the ring network 4, wherein the insertion node number is entered in a field NNF contained in the header field of the packet.

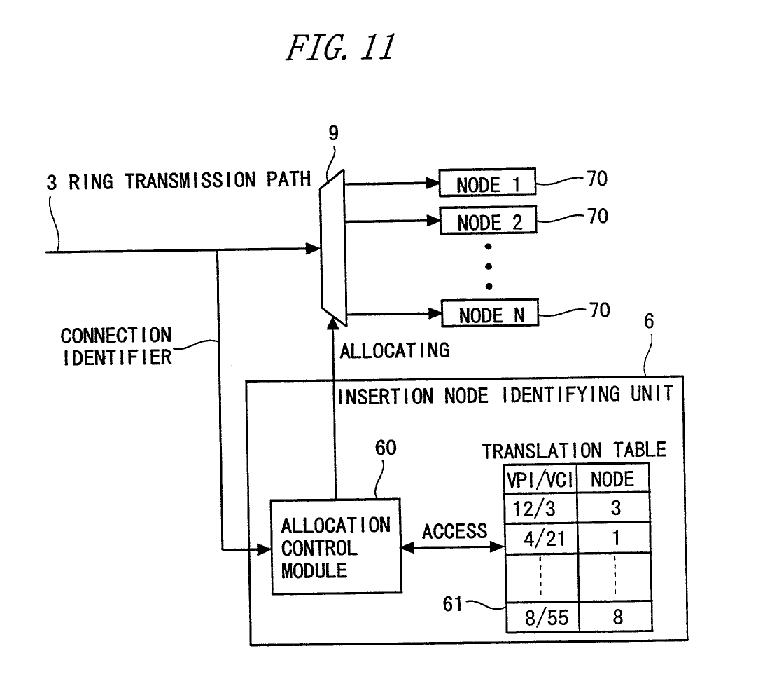

FIG. 11 illustrates an example of an architecture of the insertion node identifying unit 6, to which a second packet allocation control scheme is applied. As shown in FIG. 11, the allocation control module 60 in the insertion node identifying unit 6, when the packets reach the node 2 via the ring transmission path 3, at first extracts connection identifiers (traffic identifiers) as insertion node identifying information from the packet header fields.

Next, the allocation control module accesses a translation table 61 and obtain (insertion) node numbers corresponding to the extracted connection identifiers, and controls the multiplexing/demultiplexing module 9 so that the packets are properly allocated to the individual buffer memories 70 of the every-insertion-node oriented buffer unit 7 on the basis of these pieces of number information.

Namely, the insertion node identifying unit in this example is not, unlike the insertion node identifying unit 6 to which the first packet allocation control scheme described above is applied, provided with the special field NNF for describing the insertion node number within each packet header field. Then, the packets are allocated by use of the translation table 61 stored with mappings between the insertion node numbers and the connection identifiers such as VPI/VCI (Virtual Path Identifier/Virtual Channel Identifier) of an ATM (Asynchronous Transfer Mode) cell and an IP address of an IP (Internet Protocol) packet by which the connection can be uniquely determined.

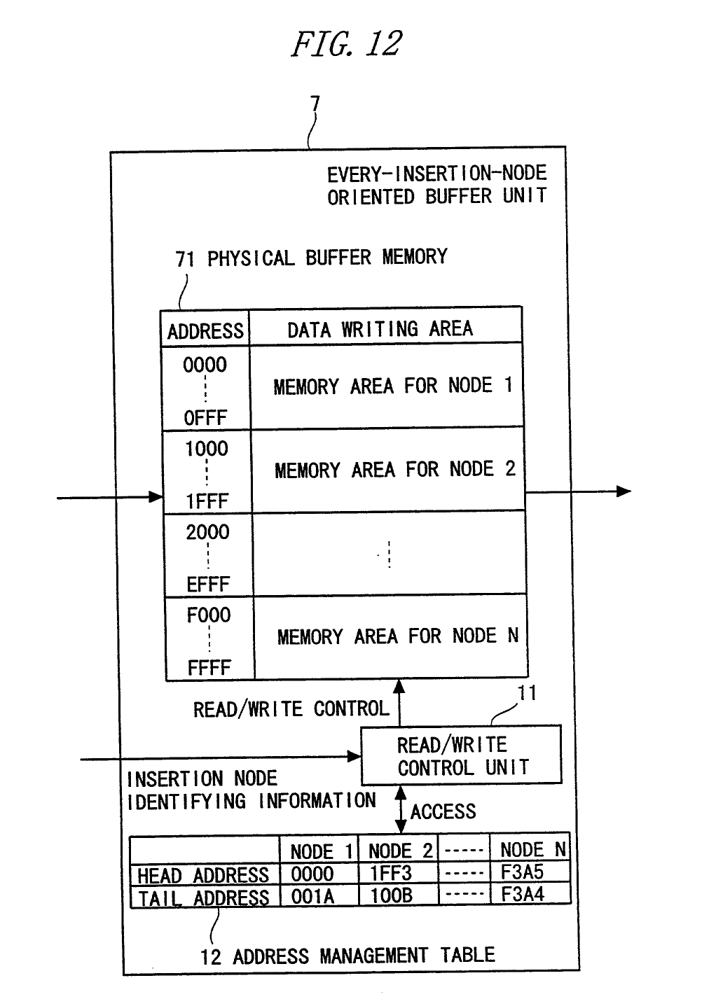

FIG. 12 shows an second architectural example of the every-insertion-node oriented buffer unit 7 illustrated in FIG. 2. As shown in FIG. 12, in the every-insertion-node oriented buffer unit 7 in the second architectural example, an entire memory area (data writing area) of the buffer memory for each of the insertion nodes (1 through N) is physically segmented into a plurality of memory areas. Then, the packets are queued up into these dedicated memory areas, individually.

In this case, the every-insertion-node oriented physical buffer memory 71 of which the entire memory area is physically segmented into the plurality of memory areas, is defined as a memory where the packets are queued up, and writable location thereof is previously determined for every insertion node.

Further, the every-insertion-node oriented buffer unit 7 in the second architectural example includes a read/write (location) control module 11 and an address management table 12. The read/write control module 11 and the address management table 12 substitute for the functions of the multiplexing/demultiplexing module 9 and the multiplexing module 10 as the components of the every-insertion-node oriented buffer unit 7 in the first architectural example shown in FIG. 2.

The address management table 12 is stored with pieces of information needed for the control of reading or writing the packet, such as a head address and a tail address per node in the physical buffer memory 71 in which the packets are actually queued up.

The read/write control module 11 accesses the address management table 12 on the basis of the insertion node identifying information registered in the header field of the arrived packet which is inputted from the insertion node identifying unit 6, and controls writing the arrived packet to the physical buffer memory 71.

Further, the read/write control module 11 accesses the address management table 12 and controls reading the packet outputted from the physical buffer memory 71.

Moreover, the read/write control module 11, if a size of the arrived packets is larger than the free memory area of the corresponding node, discards the packets, and updates the address management table 12.

Note that the physical buffer memory 71, when taking the second architectural example of the every-insertion-node oriented buffer unit 7, substitutes for the individual buffer memory 70 in the architectural example shown in FIG. 2, and neither the multiplexing/demultiplexing module 9 nor the multiplexing module 10 is required.

According to the second architectural example, the buffer memory architecture, which is easy of implementation but is not affected by the traffic from other insertion nodes, can be actualized.

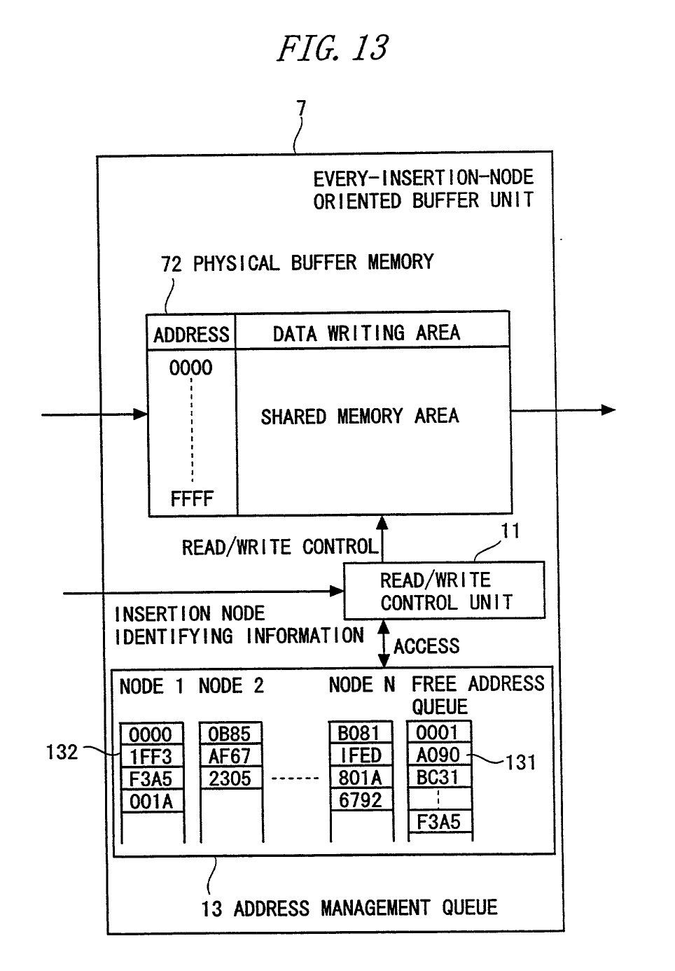

FIG. 13 shows a third architectural example of the every-insertion-node oriented buffer unit 7 shown in FIG. 2. As illustrated in FIG. 13, in the every-insertion-node oriented buffer unit 7 in the third architectural example, the memory area (data writing area) of the buffer memory is used as a shared memory area, and the packets can be queued up into arbitrary addresses “0000-FFFF” of this shared memory area.

In this case, the physical buffer memory 72 is defined as a shared memory in which the packets are queued up, and there is no particular limit to the packet writing location related to the insertion node.

Further, the every-insertion-node oriented buffer unit 7 includes the read/write (location) control module 11 and an address management queue 13. The read/write control module 11 and the address management queue 13 substitute for the functions of the multiplexing/demultiplexing module 9 and the multiplexing module 10 as the components of the every-insertion-node oriented buffer unit 7 in the first architectural example shown in FIG. 2.

The address management queue 13 has logical address queues 132 provided for the respective nodes, wherein address locations of the physical buffer memory 72 queued up with the packets are arranged in sequence of the packet arrivals. Besides, the address management queue 13 is provided with a free address queue 131 in which free addresses are accumulated.

The read/write control module 11 accesses the address management queue 13 on the basis of the insertion node identifying information in the arrived packet header field which is inputted from the insertion node identifying unit 6, and controls writing the arrived packet to the physical buffer memory 72.

Further, the read/write control module 11 accesses the address management queue 13 and controls reading the packet outputted from the physical buffer memory 72.

Moreover, the read/write control module 11, if a size of the arrived packets is larger than the free memory area, discards the packets, and updates the address management queue 13.

In the case of taking the third architectural example of the every-insertion-node oriented buffer unit 7, the address management queue 13 and the physical buffer memory 72 cooperate with each other, whereby the physical buffer memory 72 becomes equivalent to the dynamically logically segmented architecture.

Note that the individual buffer memory 70 in the architectural example illustrated in FIG. 2 is, when taking the third architectural example, replaced by the physical buffer memory 72, and neither multiplexing/demultiplexing module 9 nor the multiplexing module 10 is required.

According to the third architectural example, the physical buffer memory 72 can be effectively utilized, and it is possible to decrease the possibility in which the packets are to be discarded due to an overflow of the packets from the buffer.

Operation of Ring Network System

Next, an operation of the ring network system 1 in one embodiment of the present invention will be explained referring to FIGS. 1 through 13.

In the ring network system 1 illustrated in FIG. 1, when the packet reaches a certain node 2 via the ring transmission path 3, the destination identifying unit 5 (see FIG. 2) of this node 2 identifies a destination node based on the destination node information registered in the header field of this packet.

As a result of this identification, the destination identifying unit 5, if addressed to the self-node, takes this packet out of the ring network 4 (more precisely, out of the ring transmission path). If addressed to other node, the destination identifying unit 5 sends this packet to the insertion node identifying unit 6 in order to temporarily store (buffering) the packet in the every-insertion-node oriented buffer unit 7.

The insertion node identifying unit 6 controls allocating the packets to the individual buffer memories 70 of the every-insertion-node oriented buffer unit 7 on the bass of the insertion node specifying information registered in the header fields of the packets sent therefrom. More precisely, the insertion node identifying unit 6 controls the multiplexing/demultiplexing module 9 having a function as a selector to allocate the packets to the individual buffer memories 70. If unnecessary for particularly specifying it, the discussion will proceed on, though not explained, the assumption that the multiplexing/demultiplexing module 9 exists.

Herein, when the insertion node identifying unit 6 takes the architecture shown in FIG. 9, the allocation control module 60 refers to the insertion node number field NNF (see FIG. 10) in the packet header fields, and immediately controls allocating the packets to the individual buffer memories 70 on the basis of the insertion node numbers as the insertion node identifying information.

Further, when the insertion node identifying unit 6 takes the architecture shown in FIG.11, the connection identifier categorized as the insertion node identifying information is sent to the insertion node identifying unit 6, and hence the allocation control module 60 temporarily accesses the translation table 61 and thus obtains the insertion node number corresponding to this connection identifier (VPI/VCI). Then, the allocation control module 60 controls properly allocating the packet to the individual buffer memory 70 on the basis of this insertion node number.

The packets allocated under the control of the insertion node identifying unit 6 are queued up (buffering) into the corresponding individual buffer memories of the every-insertion-node oriented buffer unit 7.

Herein, in the case of taking the architecture of the every-insertion-node oriented buffer unit 7 illustrated in FIG. 12, an entire memory area of the physical buffer memory 71 serving as the individual buffer memory 70 is physically segmented into a plurality of memory areas, thus limiting every data writing area.

Accordingly, when the packet arrives at, e.g., the insertion node (1) 2 from a certain node 2, the reading/writing control unit 11 at first accesses the address management table 12, there by obtaining a present tail address “00-A” corresponding to the node (1) 2. Then, the reading/writing control unit 11 writes the arrived packet to a next address “001” in the physical buffer memory 71, and updates the tail address to “001B” in the filed corresponding to the node (1) in the address management table 12.

The reading/writing control unit 11, when reading the packet from the physical buffer memory 71 corresponding to, e.g., the node (1), accesses the address management table 12, thereby obtaining a head address “0000” corresponding to the node (1). Then, the reading/writing control unit 11 extracts the packet from this address “0000” in the physical buffer memory 71 and forwards this packet.

Moreover, when taking the architecture of the every-insertion-node oriented buffer unit 7 shown in FIG. 13, the reading/writing control unit 11 may write the arrived packet to an arbitrary free shared memory area having any one address “0000 through FFFF” of the physical buffer memory 72 serving as the individual buffer memory 70 of which the entire memory area can be dynamically logically segmented, and a logical every-insertion-node oriented queue is formed by use of the packet-written address number.

For example, when the packet arrives at a certain node 2 from the insertion node (2) 2, the reading/writing control unit 11 at first accesses the address management queue 13, and thus obtains a head address “0001” in a free address queue 131.

Next, the reading/writing control unit 11 writes the arrived packet to this address “0001” in the physical buffer memory 72, and stores this address “0001” in the tail of a logical address queue 132 corresponding to the node (2) in the address management queue 13.

Further, the reading/writing control unit 11, when reading the packet from the physical buffer memory 72 corresponding to, e.g., the node (1), accesses the address management queue 13, thereby obtaining a head address “0000” in the logical address queue 132 corresponding to the node (1).

Subsequently, the reading/writing control unit 11 extracts the packet from this address “0000” in the physical buffer memory 72 and forwards this packet. With this processing, the address “0000” becomes free, and hence the reading/writing control unit 11 returns this address to the tail of the free address queue 131.

The packets queued up into the individual buffer memories 70 (the same with the physical buffer memories 71, 72) are read by the reading control unit 8 from the individual buffer memories on the basis of a predetermined reading algorithm (scheduling algorithm).

Herein, in the case of taking the architecture of the reading control unit 8 to which the first weighted read control scheme shown in FIG. 3 is applied, all the weight values are set to the same value “1” in the inter-node weight information table 81, so that the scheduling module 80 performs uniformly-weighted read scheduling based on the fair queuing algorithm.

Further, when taking the architecture of the read control unit 8 to which the second weighted read control scheme shown in FIG. 4 is applied, the weight values in the inter-node weight information table 82 are set to arbitrary values such as “3, 2, . . . 5” based on the statistic data of the respective nodes (1 through N). The scheduling module 80 performs the weighed read scheduling based on the WFQ algorithm taking the weights into consideration.

Moreover, in the case of adopting the architecture of the read control unit 8 to which the third weighted read control scheme shown in FIG. 5 is applied, the weight values in the inter-node weight information table 83 are set to values such as “15, 4, . . . 7” proportional to the insertion connection counts “15, 4, . . . 7” at the respective nodes (1 through N). The scheduling module 80 performs the weighed read scheduling based on the WFQ algorithm taking the weights into consideration.

Further, when taking the architecture of the read control unit 8 to which the fourth weighted read control scheme shown in FIG. 7 is applied, the weight values in the inter-node weight information table 84 are set to values such as “17, 6, . . . 25” proportional to total reserved bandwidths “17 Mb/s, 6 Mb/s, 25 Mb/s” in the respective nodes (1 through N). The scheduling module 80 performs the weighed read scheduling based on the WFQ algorithm taking the weights into consideration.

The ring network system 1 in one embodiment of the present invention discussed above exhibits the following effects.

(1) The bandwidths can be shared in the fair and efficient way between the nodes without requiring any complicated transfer and receipt of the information between the nodes.

(2) The buffer memory in which the packets are queued up is different in every node, and therefore the fairness about a delay and the discard in such a way that the traffic of a certain node does not affect other nodes.

(3) The bandwidths can be uniformly allocated between the nodes.

(4) The weighted read based on the arbitrary fair rule can be attained.

(5) The broader bandwidth can be allocated to the node having the larger connection count, and it is therefore possible to attain the fair allocation of the bandwidth depending on the connection count.

(6) In the case of the ring network architecture in which the priority is given to every connection and the broader reserved bandwidth is allocated to the connection having the higher priority, the broader bandwidth can be allocated to the node having the higher priority connection though equal in their connection count.

(7) The buffer memory area for every node can be ensured, and hence the buffer memories can be allocated in the fair way between-the nodes.

(8) The free buffer memory area can be shared, so that the buffer memory can be efficiently used.

(9) The insertion node identifying unit refers to the insertion node number field of the arrived packet and does not therefore retain the information table (translation table), and it is therefore feasible to reduce both a size of the hardware and a processing delay due to the table access.

(10) The packets can be queued up into the proper buffer memory for every node without specifying any special packet format within the ring network.

Modified Example

The processes executed in embodiments discussed above can be provided as a program executable by a computer, and this program can be recorded on a recording medium such as a CD-ROM, a floppy disk etc and can be distributed via a communication line.

Further, the respective processes in one embodiment discussed above may be executed in a way that selects an arbitrary plurality of or all the processes and combines these processes.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. A node in a ring network system in which a plurality of nodes are connected in loop through a ring transmission path, comprising:
a storage unit having storage areas according to insertion nodes at which arrived packets are inserted into said ring transmission path, and accumulating the packets in said storage areas according to said insertion nodes; and
a read control unit reading the packets in a fair way on the basis of predetermined weights respectively from said storage areas according to said insertion nodes.

2. A node according to claim 1, further comprising:
an identifying unit identifying said insertion node at which the packets are inserted into said ring transmission path on the basis of specifying information contained in the packet; and
an accumulation control unit accumulating the packets in the corresponding every-insertion-node oriented storage area on the basis of a result of identifying said insertion node.

3. A node according to claim 1, further comprising a storage module stored with mappings between uniform weight values as the predetermined weights and said insertion nodes.

4. A node according to claim 1, further comprising a storage module stored with mappings between weight values different from each others as the predetermined weights and said insertion nodes.

5. A node according to claim 4, wherein the weight values different from each other as the predetermined weights are proportional to the number of connections for inserting the packets.

6. A node according to claim 4, wherein the weight values different from each other as the predetermined weights are proportional to a total sum of reserved bandwidths of the connection for inserting the packets.

7. A node according to claim 2, wherein the every-insertion-node oriented storage area of said storage unit is physically segmented into a plurality of areas, and said accumulation control unit permits only the packet from said corresponding insertion node to be written to each of the segmented areas of the every-insertion-node oriented storage area.

8. A node according to claim 2, wherein the every-insertion-node oriented storage areas of said storage unit are provided by dynamically logically segmenting a shared storage area, and
said accumulation control unit writes the packet from said corresponding insertion node to each of the every-insertion-node oriented storage areas into which the shared storage area is dynamically logically segmented.

9. A node according to claim 2, wherein said identifying unit identifies said insertion node at which the packet is inserted into said ring transmission path on the basis of the insertion node number as the specifying information contained in the packet.

10. A node according to claim 2, further comprising a storage module stored with mappings between traffic identifiers of the packets and the insertion node numbers, and
wherein said identifying unit identifying said insertion node at which the packet is inserted into said ring transmission path on the basis of the insertion node number corresponding to the traffic identifier, as the specifying information contained in the packet, which is obtained by referring to said storage module.

11. A packet control method in a ring network system in which a plurality of nodes are connected in loop through a ring transmission path, comprising:
providing storage areas according to insertion nodes at which arrived packets are inserted into said ring transmission path, and accumulating the packets in said storage areas according to said insertion nodes; and
reading the packets in a fair way on the basis of predetermined weights respectively from said storage areas according to said insertion nodes.

12. A packet control method according to claim 11, further comprising:
identifying said insertion node at which the packets are inserted into said ring transmission path on the basis of specifying information contained in the packet; and
accumulating the packets in the corresponding every-insertion-node oriented storage area on the basis of a result of identifying said insertion node.

13. A packet control method according to claim 11, further comprising storing mappings between uniform weight values as the predetermined weights and said insertion nodes.

14. A packet control method according to claim 11, further comprising storing mappings between weight values different from each others as the predetermined weights and said insertion nodes.

15. A packet control method according to claim 14, wherein the weight values different from each others as the predetermined weights are proportional to the number of connections for inserting the packets.

16. A packet control method according to claim 14, wherein the weight values different from each other as the predetermined weights are proportional to a total sum of reserved bandwidths of the connection for inserting the packets.

17. A packet control method according to claim 12, further comprising permitting only the packet from said corresponding insertion node to be written to each of a plurality of physically segmented areas of the every-insertion-node oriented storage area.

18. A packet control method according to claim 12, further comprising writing the packet from said corresponding insertion node to each of the every-insertion-node oriented storage areas into which a shared storage area is dynamically logically segmented.

19. A packet control method according to claim 12, further comprising identifying said insertion node at which the packet is inserted into said ring transmission path on the basis of the insertion node number as the specifying information contained in the packet.

20. A packet control method according to claim 12, further comprising:
storing mappings between traffic identifiers of the packets and the insertion node numbers; and
identifying said insertion node at which the packet is inserted into said ring transmission path on the basis of the insertion node number corresponding to the traffic identifier, as the specifying information contained in the packet, which is obtained by referring to a content of the storage.
